(19) United States
(12) Patent Application Publication
(10) Pub. No.: US 2004/0028870 A1
(43) Pub. Date: Feb. 12, 2004

(54) Laminate inlay process for sports boards

(76) Inventor: Gregory S. Lehr, Coronado, CA (US)

Correspondence Address: KOLISCH HARTWELL, P.C., 520 S.W. YAMHILL STREET, SUITE 200, PORTLAND, OR, 97204, US

(21) Appl. No.: 10/359,018

(22) Filed: Feb. 4, 2003

Related U.S. Application Data
(60) Provisional application No. 60/355,613, filed on Feb. 5, 2002.

(51) Int. Cl. B44C 1/26

(52) U.S. Cl. 428/67; 428/71

(57) ABSTRACT

The present invention provides a method for inlaying a design into a laminate sheet and bonding the inlaid laminate sheet to a core structure or core substrate. The method of the present invention includes the steps of die cutting a preselected inlay design out of a laminate sheet, die cutting a congruent insert to be placed in the aperture left by the die cut design, taping the insert into the die cut design aperture, laminating with heat and pressure the laminate sheet to a core material, removing the tape from the laminate sheet, and conducting a finishing operation such as trimming to clean the excess laminate sheet from around the edges of the core material.

### CROSS-REFERENCE TO RELATED APPLICATION

This application claims priority to U.S. Provisional Patent Application Serial No. 60/355,613, filed Feb. 5, 2002 and entitled “Laminate Inlay Process for Sports Boards”.

### FIELD OF THE INVENTION

The present invention relates generally to a method for creating an inlay pattern in a laminate sheet. More specifically, the present invention relates to a method for creating an inlay pattern in a laminate sheet and laminating the inlaid sheet into a composite laminate structure. The present invention finds particular utility for the top skin for a sports board, such as a snow sled or bodyboard.

### BACKGROUND OF THE INVENTION

Laminate sheets are useful in a variety of manufacturing processes. Laminate sheets may be bonded together to form a composite structure having layers of different materials. For example, foam core structures may have protective layers of laminated sheets attached to the outer surface thereof. Typical uses are again, snow sleds and bodyboards.

### SUMMARY OF THE INVENTION

The present invention provides a method for inlaying a design into a laminate sheet and bonding the inlaid laminate sheet to a core structure or core substrate. The method of the present invention includes the steps of die cutting a preselected inlay design out of a laminate sheet, die cutting a congruent insert to be placed in the aperture left by the die cut design, taping the insert into the die cut design aperture, laminating with heat and pressure the laminate sheet to a core material, removing the tape from the laminate sheet, and conducting a finishing operation such as trimming to clean the excess laminate sheet from around the edges of the core material.

### BRIEF DESCRIPTION OF THE DRAWINGS

FIG. 1 is a plan view of laminate sheet having a die cut inlay design cut therein according to the present invention.

FIG. 2 is a plan view of a laminate sheet having a die cut inlay design removed, the laminate sheet having at least one different material characteristic than that of FIG. 1.

FIG. 3 is a plan view of the removed die cut inlay design from the laminate sheet of FIG. 2.

FIG. 4 is a plan view of the laminate sheet of FIG. 1, having the die cut inlay design removed, and showing the die cut inlay design of FIG. 3 taped into the cut out of the laminate sheet of FIG. 1, shown positioned over a core structure indicated by dashed lines.

FIG. 5 is side view of the taped laminate sheet of FIG. 4 being fed through a laminating device and bonded to the surface of a core structure.

FIG. 6 is a plan view of the laminate sheet of FIG. 4 after it has been bonded to the core structure, showing the tape removed.

FIG. 7 is a laminated sheet according to the present invention after it has been bonded to a core structure, showing another embodiment of the die cut inlay design.

FIG. 8 is a laminated sheet according to the present invention after it has been bonded to a core, showing still another embodiment of the die cut inlay design.

### DETAILED DESCRIPTION OF THE INVENTION

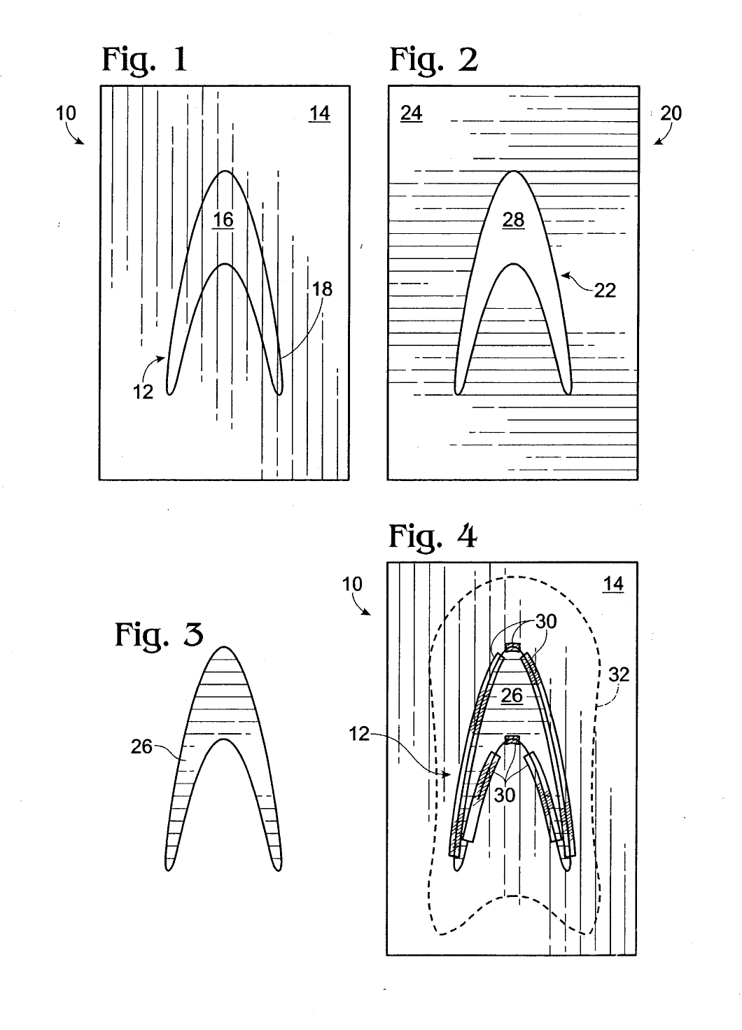

The present invention is a method for making and applying an inlaid laminate sheet to a core structure or core substrate, and is particularly useful for forming tip skin designs on sports boards such as snow sleds and body boards. Top skin material may include polyethylene foam, in the range of about 1/16″ to ¼″ thick, and with a density in the range of about 4-8 lbs/ft³. A first laminate sheet 10 having a die cut inlay periphery or design 12 is shown in FIG. 1, and includes a surrounding expanse or portion 14 and an insert portion 16. Insert portion 16 fills a die cut design aperture 18. The shape and size of insert portion 16 and design aperture 18 are preselected, and are the same as the shape and size of inlay design 12.

FIG. 2 shows a second laminate sheet 20, which includes a congruent die cut inlay design 22 sized and shaped to match die cut design 12 of FIG. 1. Second laminate sheet 20 further includes a surrounding expanse or portion 24 surrounding die cut design 22. An insert portion 26 has been removed from second laminate sheet 20 in FIG. 2, leaving a corresponding or matching design outline or aperture 28. Insert portion 26 is shown isolated in FIG. 3, prior to its being inlaid in another sheet.

Laminate sheet 10 and laminate sheet 20 are different from one another in at least one material characteristic. For example, laminate sheet 10 may be red in color and laminate sheet 20 may be blue in color. Other color differences may exist between laminate sheet 10 and laminate sheet 20. For example, laminate sheet 10 may be any color and laminate sheet 20 may be any other color including a lighter or darker shade of the same color as laminate sheet 10. The idea is contrasting colors, to enhance the appearance of the laminated sheet.

Other material characteristics may be different between laminate sheet 10 and laminate sheet 20. The surface properties of the sheets may be different. For example, sheet 10 may have a relatively low coefficient of friction and sheet 20 may have a relatively high coefficient of friction. Also the reverse may be true, and sheet 10 may have a relatively high coefficient of friction and sheet 20 may have a relative low coefficient of friction. Variation in the coefficient of friction may be the result of a surface treatment or an inherent material property. Increases in the coefficient of friction increase the purchase, or grip, that the surface has on an adjacent surface.

The matching die cut inlay designs 12 and 22 enable inserts 16 and 26 to be removed from sheets 10 and 20 and interchanged. Replacing insert 16 with insert 26 in sheet 10 makes a laminate sheet having an outer portion 14 of one material characteristic and an insert 26 of another material characteristic. Similarly, replacing insert 26 with insert 16 in sheet 20 makes a laminate sheet having an outer portion 24 of one material characteristic and an insert 16 of another material characteristic. The interchangeability may be used to enhance the characteristics of the composite structure. For example, if the composite structure is a snow sled or body board, an increase in the purchase of a rider surface may enhance the play value of the snow sled. The color of the insert may be different from that of the surrounding expanse, enhancing the visual aesthetics of the sports board.

Laminate sheet 10 may be a variety of polymer materials. For example, polyethylene, polystyrene, polypropylene, and polyvinylchloride may be used to form laminate sheet 10.

A method of making an inlaid laminate sheet and applying it to a substrate, such as the foam core of a sports board, such as a snow sled, will be better understood with reference to FIGS. 1-6. Starting at FIG. 1, die cut design 12 is cut into laminate sheet 10. Die cut design 12 may be cut using conventional stamping, like a “cookie cutter,” laser cutting, water jet cutting, or similar cutting techniques. Die cut design 12 forms separable insert portion 16, which will be removed from laminate sheet 10 leaving an inlay aperture 18. Inlay aperture 18 is sized to provide a corresponding periphery to receive an inlay piece to be inserted into laminate sheet 10.

As shown in FIG. 2, an inlay piece has been removed from second laminate sheet 20 leaving an inlay aperture 28. Insert portion, or inlay piece 26 is shown in FIG. 3. Inlay piece 26 is oriented to lie within inlay aperture 18 and secured to laminate sheet 10 by adhesive tape 30 stretched along and secured to opposites sides of the boundary defined by aperture 18, as shown in FIG. 4. Inlay piece 26 may be inlaid and secured in place manually, or using an automated process. Laminate sheet 10, with inlaid piece 26 taped into position or otherwise secured, is now shifted and placed directly over a substrate such as foam core 32, shown in dashed lines in FIG. 4. That foam core defines the outline of a sports board, such as a snow sled or bodyboard. While inlay piece 26 is shown taped into position it should be understood that other suitable means for securing inlay piece 26 may be used, such as an adhesive layer, or electrostatic bonds, etc.

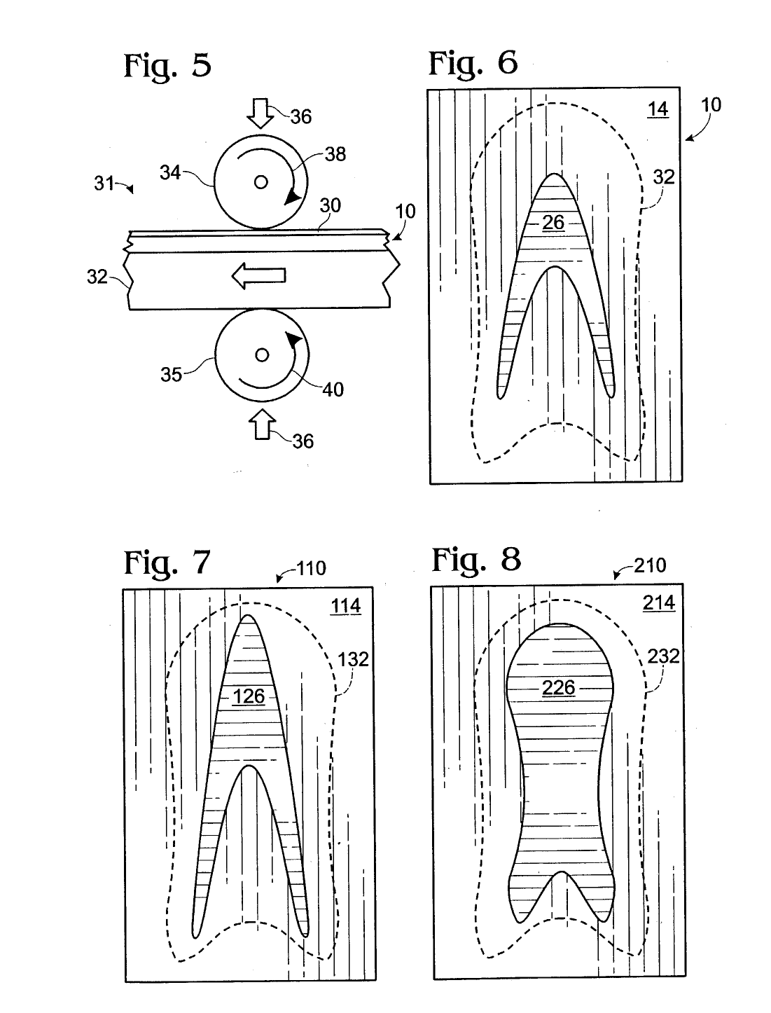

Laminate sheet 10 and substrate core 32 are then laminated together, as shown in FIG. 5. Substrate core 32 and laminate sheet 10 may be fed through a roll-press-laminating device 3 1, and heat in the range of about 375° F. ensures lamination. The laminating device may include a pair of rollers 34 and 35 positioned to sandwich laminate sheet 10 and substrate core 32 together as indicated by arrows 36. As shown in FIG. 5, roller 34 is adjacent laminate sheet 10 and may be heated to facilitate bonding between laminate sheet 10 and substrate core 32. Roller 34 rotates in the direction, as indicated by arrow 38, while roller 35 rotates in the opposite direction, as indicated by arrow 40, to move both the substrate core 32 and laminate sheet 10 through the laminating device.

It can be seen that tape 30 may be secured in place while laminate sheet 10 is being bonded to substrate core 32 in the laminating device. Tape 30 ensures that inlay piece 26 remains properly aligned and secured in place during the laminating process. As a result of the laminating process, inlay piece 26 and laminate sheet 10 are both bonded in place to substrate core 32. Thereafter, the tape 30 may be removed. FIG. 6 shows laminate sheet 10 and insert potion 26 bonded to substrate core 32 with tape 30 removed.

It should be understood that any die cut inlay design may be cut out of laminate sheets 10 and 20, provided two requirements are met. The first is that the design dimensions are contained within the boundary of the exterior edge of substrate core 32. The second requirement is that the design cut out of laminate sheet 10 be substantially the same size and shape as the design cut out of laminate sheet 20. The aperture formed in the die cutting process is maintained within the boundaries of the laminate sheet. This is important because it is necessary to bond the sheet, using the inlay to the substrate core.

After the laminated sheet 10 and inlay piece 26 have been laminated onto substrate core 32, the loose edges of the sheet are “heeled” around the chine and edges of the board, and are laminated to the chine by a heat gun. Excess material is then suitably trimmed away with a knife.

In the process shown, the laminate sheets may be sized about 22″ wide by 46″ or so in length, suitable for snow sled and bodyboard constructions.

The present invention avoids wastage of laminate sheet material in a production process. For example, as a die cut is made on one sheet to create an inlay portion, that first sheet is then available to receive an inlay portion or insert from a second sheet of material. Simultaneously, the second sheet is available to receive an inlay portion from the first sheet or some other sheet having a matching or congruent inlay design.

It should also be understood that the above-described process may be repeated on laminate sheet 20 with inlay piece 16 to form a composite with the material characteristics of laminate sheet 10 in the inlay design and the material characteristics of laminate sheet 20 in the surrounding portion.

FIGS. 7 and 8 show other embodiments of inlaid laminate sheets 110 and 210 respectively. Inlaid laminate sheet 110-having an inlaid piece 126 of a different design from inlaid piece 26-is bonded to a core substrate 132. Similarly, inlaid laminate sheet 210-having an inlaid piece 226 of a different design than inlaid pieces 26 or 126-is bonded to a core substrate 232.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein.

Inventions embodied in various combinations and subcombinations of features, functions, elements, and/or properties may be claimed in a related application. Such claims, whether they are directed to a different invention or directed to the same invention, whether different, broader, narrower or equal in scope to any original claims, are also regarded as included within the subject matter of the inventions of the present disclosure.

I claim:

1. A method of inlaying a design into a laminate sheet and bonding the inlaid laminate sheet to a core structure, comprising:
cutting an inlay design out of a first laminate sheet leaving an inlay aperture;
cutting a congruent insert from a second laminate sheet to be placed in the inlay aperture of the first laminate sheet;
aligning the congruent insert in the inlay aperture;
securing the congruent insert in place in the inlay aperture;
placing the first laminate sheet with the congruent insert secured in the inlay aperture over a core structure; and
laminating the first laminating sheet with the congruent insert secured in the inlay aperture to the core structure using heat and pressure.

2. The method of claim 1, wherein the first laminate sheet and the second laminate sheet are different from one another in at lease one material characteristic.

3. The method of claim 2, wherein the at lease one material characteristic is color.

4. The method of claim 2, wherein the at least one material characteristic is a surface property.

5. The method of claim 4, wherein the surface property is the coefficient of friction.

6. The method of inlaying of claim 1, wherein cutting the inlay design out of the first laminate sheet is accomplished using the same method as cutting the congruent insert out of the second laminate sheet.

7. The method of inlaying of claim 6, wherein the cutting is done using a die cut operation.

8. The method of inlaying of claim 1, wherein the first and second laminate sheets are made from a polymer material selected from the group consisting of polyethylene, polystyrene, polypropylene, and polyvinylchloride

9. The method of inlaying of claim 1, wherein securing the congruent insert in the inlay aperture includes taping the congruent insert in place.

10. The method of inlaying of claim 1, wherein laminating the first laminating sheet to the core structure includes feeding the core structure and the first laminate sheet through a roll-press-laminating device.

11. A method of inlaying a design into a laminate sheet and bonding the inlaid laminate sheet to a core structure, comprising:
cutting an inlay design out of a first laminate sheet creating a first insert and leaving a first inlay aperture in the first laminate sheet;
cutting a congruent second insert from a second laminate sheet to be placed in the first inlay aperture of the first laminate sheet leaving a second inlay aperture in the second laminate sheet;
aligning the first insert in: the second inlay aperture and aligning the second congruent insert in the first inlay aperture;
securing the first insert in place in the second inlay aperture and securing the second insert in place in the first inlay aperture;
placing the first laminate sheet with the second congruent insert secured in the first inlay aperture over a first core structure, and placing the second laminate sheet with the first insert secured in the second inlay aperture over a second core structure; and
laminating the first laminating sheet to the first core structure using heat and pressure and laminating the second laminating sheet to the second core structure using heat and pressure.

12. The method of claim 11, wherein the first laminate sheet and the second laminate sheet are different from one another in at lease one material characteristic.

13. The method of claim 12, wherein the at lease one material characteristic is color.

14. The method of claim 12, wherein the at least one material characteristic is a surface property.

15. The method of claim 14, wherein the surface property is the coefficient of friction.

16. The method of inlaying of claim 11, wherein cutting the inlay design out of the first laminate sheet is accomplished using the same method as cutting the congruent insert out of the second laminate sheet.

17. The method of inlaying of claim 16, wherein the cutting is done using a die cut operation.

18. The method of inlaying of claim 11, wherein the first and second laminate sheets are made from a polymer material selected from the group consisting of polyethylene, polystyrene, polypropylene, and polyvinylchloride.

19. A sports board comprising:
a foam core; and
a laminate skin bonded to and covering the foam core; wherein the laminate skin includes an inlay design defined by an inlay aperture formed entirely within the laminate skin dimensioned to receive a congruent insert placed therewithin.

20. The sports board of claim 19, wherein the inlay design includes at least one material property that differs from the remaining expanse of the laminate skin.

21. The sports board of claim 20, wherein the inlay design material property that differs from the remaining laminate skin expanse includes color.

22. The sports board of claim 20, wherein the inlay design material property that differs from the remaining laminate skin expanse includes a surface property.

23. The sports board of claim 22, wherein the surface property is the coefficient of friction.
